(19) United States
(12) Patent Application Publication
(10) Pub. No.: US 2011/0131085 A1
(43) Pub. Date: Jun. 2, 2011

(54) Method, System and Computer Program Product for Advertising Supported Matchmaking Services

(76) Inventor: Lead Wey, San Francisco, CA (US)

(21) Appl. No.: 12/628,048

(22) Filed: Nov. 30, 2009

(51) Int. Cl. G06Q 30/00; G06Q 50/00; G06Q 99/00; G06F 15/16

(52) U.S. Cl. 705/14.16; 705/14.31; 705/319; 709/206

(57) ABSTRACT

A method, system and computer program product for advertising supported matchmaking services includes logging onto a matchmaking service website for accessing a basic set of matchmaking functionalities. Completing at least one specified action on the first matchmaking service website generally assists the matchmaking service website in increasing revenue. Receiving incentive points, associated with the completing of the at least one specified action, encourages a generally consistent and generally productive use of the matchmaking service website. A list of premium matchmaking functionalities enhances a use of the matchmaking service website, wherein use of each of the premium matchmaking functionalities requires a predetermined number of the incentive points.

### CROSS-REFERENCE TO RELATED APPLICATIONS

The present Utility patent application claims priority benefit of the U.S. provisional application for patent Ser. No. 61/118,382 filed on 26 Nov. 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to advertising supported, online matchmaking services or websites that match people for purposes including, but not limited to, friendship, romance, commerce, employment, question-answer, expert advice, or content. More specifically, this invention relates to a system and method for integrating a loyalty system with such online matchmaking services to influence end-user behavior, enhance end-user experience, improve end-user loyalty and increase advertising revenues generated by such websites.

### BACKGROUND OF THE INVENTION

Online matchmaking websites are extremely popular to millions of consumers. Such websites provide matchmaking services to match people for various purposes. For example, dating websites such as Match.com match people for the purposes of romance; social networking websites such as Myspace.com or Facebook.com match people for purposes of friendship or networking; classified websites such as Craigslist.org match people for various commerce and non-commerce related purposes; employment websites such as Monster.com match prospective employees with employers; question-answer websites such as JustAnswer.com match people with questions with experts who can provide answers; online auction websites such as eBay.com match sellers with buyers; search engines such as Google.com match content seekers with content providers.

Online matchmaking websites typically fund their operations by charging users a membership or subscription-fee, by selling advertising to third party advertisers or both. Increasingly, matchmaking websites are becoming 100% free for end-users, with website operations and profit completely funded by the sale of advertising. The success of any such advertising supported matchmaking website depends on the website's ability to attract a large number of users, hence generating a large number of page views or advertising inventory which may in turn be sold to generate revenue.

Since the costs of starting and maintaining most matchmaking websites are relatively low, it is not surprising to find thousands of free matchmaking websites that cater to any matchmaking purposes. The value of any matchmaking website to its users depends in part on the number of users the website is able to attract. In the case of advertising supported dating websites, Plentyoffish.com, being one of the first to launch a 100% free dating website, commands a large market share of online dating activity. Even though thousands of other 100% free dating websites have since been launched, most have not been successful in overcoming the “first mover advantage” of early entrants. This is in part due to a lack of site mechanics or business model differentiation adequate to attract large number of users.

Even after attracting a large number of users, matchmaking websites often deliver poor end-user experience due to an imbalance of supply versus demand. In the case of employment websites, there is always a much higher demand for and a much shorter supply of highly qualified workers as well as higher paying jobs. In the case of dating websites, there is always a much larger demand for and a much shorter supply of beautiful singles. A beautiful user is often overwhelmed by the number of inquiries from prospective suitors and may not have the time to respond to every inquiry received. An average user who attempts to contact such a beautiful single will likely be disappointed by never receiving a response to his or her inquiry.

Currently, advertising supported matchmaking websites treat all users equally by providing the same set of services to all users, even though users are not all equal in their contribution to the website. In the case of a dating website, users who possess qualities such as beauty, youth, or wealth are highly sought after, whereas users who lack such qualities are in lower demand. On the other hand, some users contribute more significantly to the success and profitability of the website than others. In contrast to the current practice of treating all users the same and providing the same set of services to all users, a system that improves end-user satisfaction by providing a higher level of service to users who contribute more to the success of the website is preferred.

Loyalty systems have long been employed successfully by offline merchants to increase sales and improve customer loyalty. Successful loyalty programs have been employed by airlines and credit card companies where incentive frequent flyer points are awarded to customers who purchase goods or services, usually based on the amount of money spent. Such awarded incentive points may then be redeemed for gifts or travel. While such commerce related loyalty systems have been successfully employed by offline and online merchants to increase sales, loyalty programs have yet to be successfully employed by advertising supported matchmaking websites to increase end-user loyalty.

Prior attempts at using loyalty programs to increase user loyalty towards advertising supported websites have used the same commerce related loyalty business models, whereby users are awarded points that may be redeemed for gifts, cash or a chance at winning items. During the dot-com boom years between 1998 and 2002, a number of advertising supported websites offered end-users a chance at earning cash for viewing online advertisements. Other advertising supported websites offered end-users a chance to earn loyalty points that may be used in auctions to win gifts. Yet other advertising supported websites offer end-users points that represent lottery entries giving users chances at winning daily, weekly or monthly cash rewards or gifts. Loyalty systems that provide cash incentives or free gifts tend to attract end-users who are motivated for the wrong reasons, and as such are frowned upon by advertisers. Therefore, a loyalty system for advertising supported matchmaking websites that provides non-cash and non-gift related incentives to attract users who are genuinely interested in using services offered by such websites is desirable.

Yet another issue faced by advertising supported matchmaking websites is the issue of online fraud. Since advertising supported matchmaking websites are free for end-users, anyone from anywhere can access and use the website without revealing their real identity. While matchmaking websites that charge users a fee can verify a user's authenticity through payment information, the anonymity of the internet and the lack of identity authentication have made it easy for scammers and spammers to use “free” matchmaking websites to scam other legitimate users. Therefore a loyalty system that helps advertising supported websites reduce such online fraud is desirable.

In view of the foregoing, there is a need for improved techniques for providing a loyalty system and business model whereby advertising supported matchmaking websites can influence end-user behavior, enhance end-user experience, improve end-user loyalty, lower the overall cost of operations, reduce online fraud and increase revenues generated through the sale of advertising without cash or gift related incentives.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary environment in which a loyalty system according to preferred embodiments of the present invention may be implemented, in accordance with the prior art;

FIG. 2 is a flow chart illustrating an exemplary process for awarding and redeeming loyalty points in a loyalty system, in accordance with an embodiment of the present invention;

FIG. 3 is a flow chart illustrating an exemplary process for awarding loyalty points to a user based on the actions of other users, in accordance with an embodiment of the present invention;

FIG. 4 illustrates an exemplary website page view, listing an exemplary list of reward tasks, in accordance with an embodiment of the present invention;

FIG. 5 illustrates an exemplary website page view, listing an exemplary list of premium services, in accordance with an embodiment of the present invention;

FIG. 6 is a diagram illustrating an exemplary method of how points may be awarded in a multi-level incentive system, in accordance with an embodiment of the present invention;

FIG. 7 is a flow chart illustrating an exemplary process for awarding more loyalty points to users who have provided demographic data about themselves, in accordance with an embodiment of the present invention; and

FIG. 8 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method, system and computer program product for advertising supported matchmaking services is presented.

In one embodiment a method of using a system for advertising supported matchmaking services is presented. The method includes steps for accessing a first basic set of matchmaking functionalities on a first matchmaking service website, steps for generally assisting the first matchmaking service website in increasing revenue, steps for encouraging generally consistent and generally productive use of the first matchmaking service website, and steps for enhancing a use of the first matchmaking service website. Another embodiment further includes steps for increasing a rate of receiving incentive points. Yet another embodiment further includes steps for posting to attract referrals. Still another embodiment further includes steps for inviting a recipient to register at the first matchmaking service website. Other embodiments further include steps for referring a new user for registration, steps for receiving a first percentage of incentive points received by the new user and steps for receiving a second percentage of incentive points received by an additional new user referred by the new user. Yet other embodiments further include steps for accessing a second basic set of matchmaking functionalities on a second matchmaking service website, steps for generally assisting the second matchmaking service website in increasing revenue and steps for encouraging generally consistent and generally productive use of the second matchmaking service website, wherein incentive points received at the first matchmaking service website and the second matchmaking service website are combined.

In another embodiment a system for advertising supported matchmaking services is presented. The system includes means for accessing a first basic set of matchmaking functionalities on a first matchmaking service, means for generally assisting the first matchmaking service website in increasing revenue, means for encouraging generally consistent and generally productive use of the first matchmaking service website and means for enhancing a use of the first matchmaking service website. Another embodiment further includes means for increasing a rate of receiving incentive points. Yet another embodiment further includes means for posting to attract referrals. Still another embodiment further includes means for inviting a recipient to register at the first matchmaking service website. Other embodiments further include means for referring a new user for registration, means for receiving a first percentage of incentive points received by the new user and means for receiving a second percentage of incentive points received by an additional new user referred by the new user. Yet other embodiments further include means for accessing a second basic set of matchmaking functionalities on a second matchmaking service website, means for generally assisting the second matchmaking service website in increasing revenue and means for encouraging generally consistent and generally productive use of the second matchmaking service website, wherein incentive points received at the first matchmaking service website and the second matchmaking service website are combined.

In another embodiment a method of using a system for advertising supported matchmaking services is presented. The method includes steps of logging onto a first matchmaking service website for accessing a first basic set of matchmaking functionalities. The method includes completing at least one specified action on the first matchmaking service website for generally assisting the first matchmaking service website in increasing revenue. The method further includes receiving incentive points associated with the completing of the at least one specified action for encouraging generally consistent and generally productive use of the first matchmaking service website. The method also includes receiving a list of premium matchmaking functionalities for enhancing a use of the first matchmaking service website, wherein use of each of the premium matchmaking functionalities requires a predetermined number of the incentive points. Another embodiment further includes the step of selecting a one of the premium matchmaking functionalities dependent on a number of received incentive points. In yet another embodiment the number of received incentive points is decreased by the predetermined number of the incentive points for the one of the premium matchmaking functionalities. In still another embodiment the first basic set of matchmaking functionalities and the list of premium matchmaking functionalities are divided into a plurality of service levels where each of the service levels requires a differing number of incentive points for using functionalities contained within each of the service levels. Another embodiment further includes steps of providing demographic information for increasing a rate of receiving incentive points, and receiving incentive points for providing the demographic information. Yet another embodiment further includes the step of receiving a link to the first matchmaking service website for posting to attract referrals, wherein the link identifies a referrer. Still other embodiments further include the steps of sending at least one email for inviting a recipient to register at the first matchmaking service website, where the email contains the link and receiving incentive points for sending the email. Another embodiment further includes the steps of referring a new user for registration and receiving additional incentive points amounting to a first percentage of incentive points received by the new user. Yet another embodiment further includes the step of receiving further incentive points amounting to a second percentage of incentive points received by an additional new user referred by the new user. Still another embodiment further includes the step of logging onto a second matchmaking service website for accessing a second basic set of matchmaking functionalities. Another embodiment further includes steps of completing at least one specified action on the second matchmaking service website for generally assisting the second matchmaking service website in increasing revenue and receiving incentive points associated with the completing of the at least one specified action for encouraging generally consistent and generally productive use of the second matchmaking service website, wherein incentive points received at the first matchmaking service website and the second matchmaking service website are combined. Still another embodiment further includes the step of redeeming incentive points for goods or services. Yet another embodiment further includes the step of purchasing incentive points. In still another embodiment the first matchmaking service website is a dating website, employment website, auction website, commerce website, search website, classified service website or a social networking website.

In another embodiment a computer program product for a system for advertising supported matchmaking services is presented. The computer program product includes computer program code for logging onto a first matchmaking service website for accessing a first basic set of matchmaking functionalities. Included is computer program code for completing at least one specified action on the first matchmaking service website for generally assisting the first matchmaking service website in increasing revenue. Further included is computer program code for receiving incentive points associated with the completing of the at least one specified action for encouraging generally consistent and generally productive use of the first matchmaking service website. Also included is computer program code for receiving a list of premium matchmaking functionalities for enhancing a use of the first matchmaking service website, wherein use of each of the premium matchmaking functionalities requires a predetermined number of the incentive points. A computer-readable media stores the computer program code. Another embodiment further includes computer program code for selecting a one of the premium matchmaking functionalities dependent on a number of received incentive points. In yet another embodiment the number of received incentive points is decreased by the predetermined number of the incentive points for the one of the premium matchmaking functionalities. In still another embodiment the first basic set of matchmaking functionalities and the list of premium matchmaking functionalities are divided into a plurality of service levels where each of the service levels requires a differing number of incentive points for using functionalities contained within each of the service levels. Another embodiment further includes computer program code for providing demographic information for increasing a rate of receiving incentive points and computer program code for receiving incentive points for providing the demographic information. Yet another embodiment further includes computer program code for receiving a link to the first matchmaking service website for posting to attract referrals, wherein the link identifies a referrer. Still another embodiment further includes computer program code for sending at least one email for inviting a recipient to register at the first matchmaking service website, where the email contains the link. Another embodiment further includes computer program code for receiving incentive points for sending the email. Yet another embodiment further includes computer program code for referring a new user for registration and computer program code for receiving additional incentive points amounting to a first percentage of incentive points received by the new user. Still another embodiment further includes computer program code for receiving further incentive points amounting to a second percentage of incentive points received by an additional new user referred by the new user. Another embodiment further includes computer program code for logging onto a second matchmaking service website for accessing a second basic set of matchmaking functionalities. Yet another embodiment further includes computer program code for completing at least one specified action on the second matchmaking service website for generally assisting the second matchmaking service website in increasing revenue and computer program code for receiving incentive points associated with the completing of the at least one specified action for encouraging generally consistent and generally productive use of the second matchmaking service website, wherein incentive points received at the first matchmaking service website and the second matchmaking service website are combined. Still another embodiment further includes computer program code for redeeming incentive points for goods or services. Yet another embodiment further includes computer program code for purchasing incentive points.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide a loyalty system and business model whereby advertising supported matchmaking websites can influence end-user behavior, enhance end-user experience, improve end-user loyalty, lower the overall cost of operations and increase revenues generated through the sale of advertising. Unlike prior art loyalty models, preferred embodiments provide a loyalty system for advertising supported matchmaking websites that provides non-cash and non-gift related incentives to attract users who are genuinely interested in using services offered by such websites.

Preferred embodiments of the present invention provide a unique loyalty system for advertising supported matchmaking services or websites, whereby users of the matchmaking services or websites are not required to pay a fee in order to use said services. To use the services provided by any such matchmaking services or websites implementing preferred embodiments, end users are required to register for a user account. Using the loyalty system according to preferred embodiments, user loyalty is encouraged through the awarding of points to loyal registered users, and an improved user experience is provided to the most loyal user through the redemption of points earned. The creation of a registered account may also help advertising supported websites reduce online fraud by verifying users.

In contrast to the current practice of treating all users the same and providing the same set of services to all users, preferred embodiments aim to improve end-user satisfaction by providing varying levels of service to users depending on their contribution to the success of the website. A basic level of services or functionalities is provided to all registered users, allowing them to use the services or websites for the purposes of being matched with other users or information. Loyalty or incentive points or credits are awarded for actions taken by each registered user. Such actions are determined by each matchmaking service operator to include any activity that directly or indirectly helps the service increase revenue or reduce cost. A higher level of services or functionalities (i.e., premium services) is available to help users enhance their matchmaking experience. However, such premium services are only available to registered users who redeem these services using accumulated loyalty points or credits.

User demographics and preferences provide the ability for advertisers to target their advertisements to the appropriate groups of users. As such, advertisers are willing to pay more to advertise to the appropriate groups of users. Preferred embodiments further enable website operators to award loyalty points at a faster rate to users who provide detailed information about their demographic or preferences. Such demographic or preference related data may then be passed on to advertisers, allowing advertisers to serve up higher priced targeted advertisements.

The success of any advertising supported matchmaking website depends in part on the number of users using the website. Viral marketing occurs when a user of a website tells his friends about the website. A user who refers other users to use the website becomes a parent user, whereas the users he refers to register as users of the website become his child users. Preferred embodiments of the present invention further enable website operators to award loyalty points to each parent user based on activities of his child users. In doing so, website operators are able to encourage viral marketing by its users.

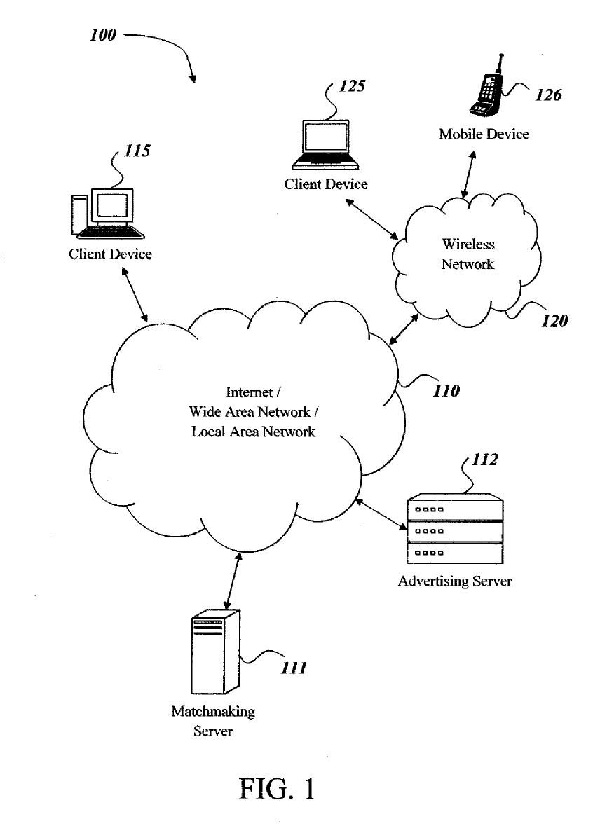

FIG. 1 illustrates an exemplary environment in which a loyalty system according to preferred embodiments of the present invention may be implemented, in accordance with the prior art. The environment described is well understood by those skilled in the art and is commonly practiced in the implementation of any interactive online or mobile services. It is important to note that not all components may be required to implement preferred embodiments of the present invention, and variations in the arrangement or type of components may be made without departing from the scope of the present invention. It is equally important to note that while technologies, computing standards, software languages, or telecommunication protocols may change over time, such changes may happen without departing from the scope of the present invention. In the present example, a system 100 comprises a network 110, a wireless network 120, a matchmaking sever 111, an advertising server 112, a client device 115, a client device 125 and a mobile device 126. Preferred embodiments may also be implemented in environments comprising multiple client devices and multiple mobile devices.

Network 110 may be any communications network capable of transferring data, such as, but not limited to, the internet, a wide area network (WAN), or a local area network (LAN). Connected to network 110 are matchmaking server 111, advertising server 112 and client device 115. Wireless network 120 is configured to couple client device 125 and mobile device 126 with network 110. Wireless network 120 may be any wireless communications network capable of transferring data, including, without limitation, wide area wireless networks such as, but not limited to, those operated by ATT, Verizon, Sprint, or T-mobile, as well as local wireless networks such as, but not limited to, a public hotspot or a private wireless local area network (WLAN). Wireless network 120 may further include an autonomous system of terminals, gateways, routers, and the like connected by wireless radio links and the like. These connections may be configured to move freely and randomly and organize themselves arbitrarily, such that the topology of wireless network 120 may change rapidly.

Generally, client devices 115 and 125 and mobile device 126 are devices that comprise any computing devices capable of receiving and sending data over a network, such as, but not limited to, network 110 or wireless network 120, to and from other computing devices, such as, but not limited to, matchmaking server 111, advertising server 112, other mobile devices, other client devices, etc. Client devices 115 and 125 and mobile device 126 may include devices that typically connect using a wired communications medium, such as, but not limited to, personal computers, multiprocessor systems, laptops, think-clients, microprocessor-based or programmable consumer electronics, network PCs, etc., and these devices may also include devices that typically connect using a wireless communication medium, such as, but not limited to, cell phones, smart phones, pagers, walkie-talkies, PDAs, tablet computers, handheld computers, wearable computers, RF devices, infrared devices, Bluetooth enabled devices, laptops, PCs, integrated devices combining one or more of the preceding devices, any mobile devices, etc.

Client devices 115 and 125 and mobile device 126 may include a browser application capable of receiving and sending information such as, but not limited to, web pages, messages, etc. This browser application may be configured to receive and displace graphics, text, and multimedia employing virtually any web based language including, but not limited to, SMGL, HTML, WML, WAP, HDML, WML Script, JavaScripts, etc. Client devices 115 and 125 and mobile device 126, may also include a client application that enables them to perform a variety of other functions including, but not limited to, communicating a message between the device and other computing devices through any message protocols or methods that may include, without limitation, SMS, MMS, IM, IRC, mIRC, Jabber, browser plug-ins, etc.

Client devices 115 and 125 and mobile device 126 may also be devices configured to allow users to participate in an online matchmaking service, which may be provided by matchmaking server 111. As such, client devices 115 and 125 and mobile device 126 may include a client application that is configured to manage various actions on behalf of the client device. For example, without limitation, the client application may enable a user to interact with the browser application, email application, and the like to manage their online posting or profile information. The client application may further enable the user to receive and interact with results of a search that is based in part on the user's input to the matchmaking service.

Generally, matchmaking server 111 may include any computing device capable of connecting to network 110 to enable users using client devices 115 and 125 and mobile device 126 to manage their matchmaking activities and related information. Matchmaking server 111 may include devices such as, but not limited to, personal computers, desktop computers, laptops, servers, programmable devices or hardware, cable or set-top boxes, smart phones, internet enabled kiosk, embedded devices, etc. Furthermore, matchmaking server 111 is capable of running software or an application capable of delivering matchmaking services via an online website, portal, etc. Matchmaking service may be any service that matches one set of users with another set of users, and may include, but is not limited to, the following: dating services that match users with other users for the purposes of romance or love; employment services that match users who are job seekers with users who are employers; auction services that match users who are buyers with users who are sellers; classifieds services that match users who have a posting with users who would like to respond to one or more published postings; ecommerce services that match consumers with merchants; question-answer services that match users who seek answers to questions with experts who may provide answers; search engine services that match users who seek content with content providers, etc.

Advertising server 112 may include any computing device capable of connecting to network 110 and running software that serves up online advertisements. Advertising server technologies are well understood by those skilled in the art and are widely employed by online advertising networks, such as, but not limited to, Google AdWords and AdSense, Yahoo Search Advertising, etc. An advertising network is a company that connects websites that want to host advertisements with advertisers who want to run advertisements. In the present example, a web page served from matchmaking server 111 and executed on client devices 115 and 125 and mobile device 126 may include a software code that makes a call to advertising server 112, which in turn responds with an online advertisement that is then displayed within the web page on client devices 115 and 125 and mobile device 126. Advertising displayed may be in various forms such as, but not limited to, banner ads, rich media, text links, interstitials, voiceovers, pop ups, etc.

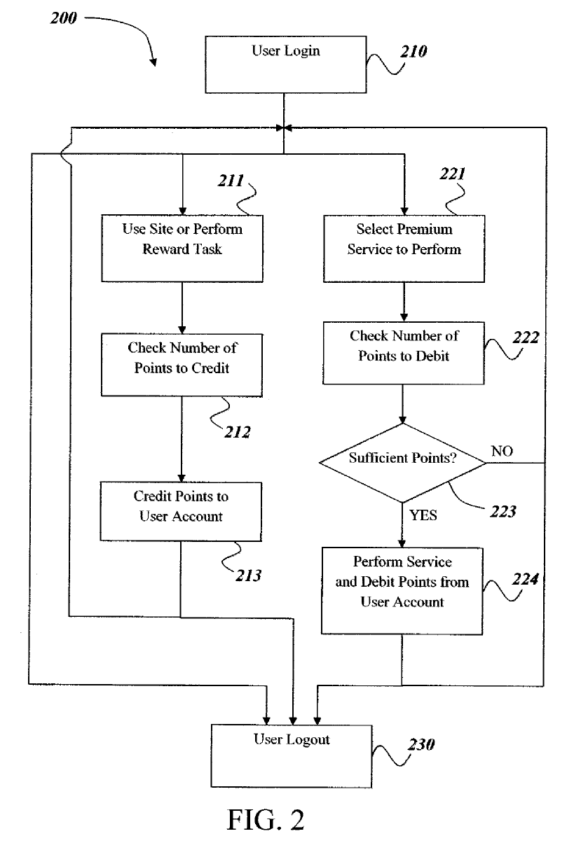

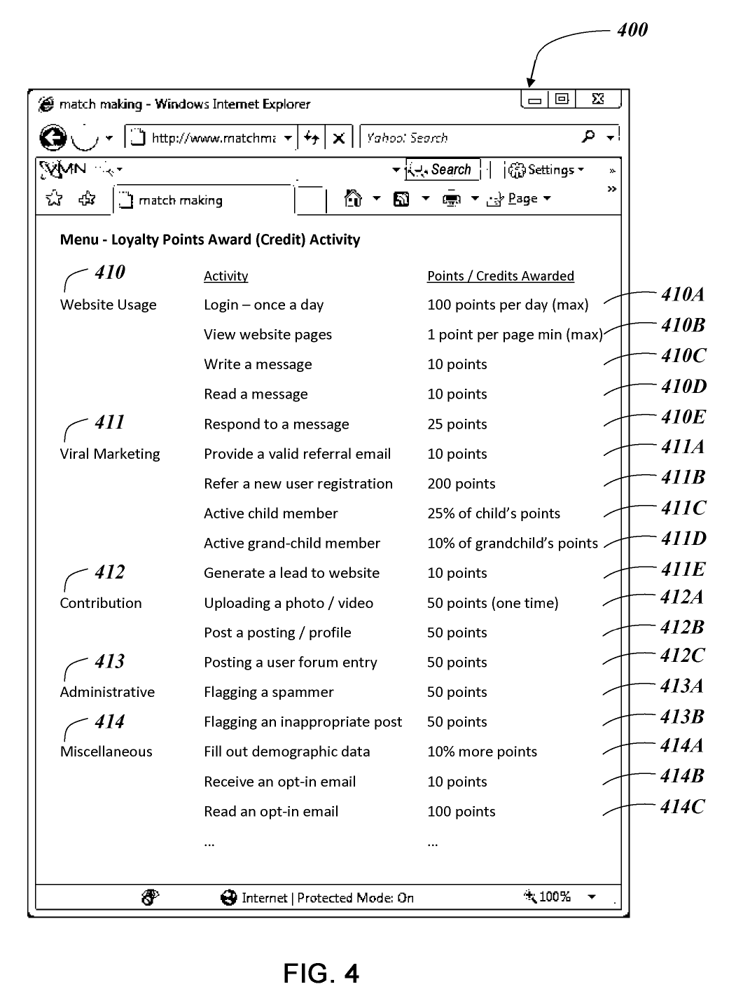

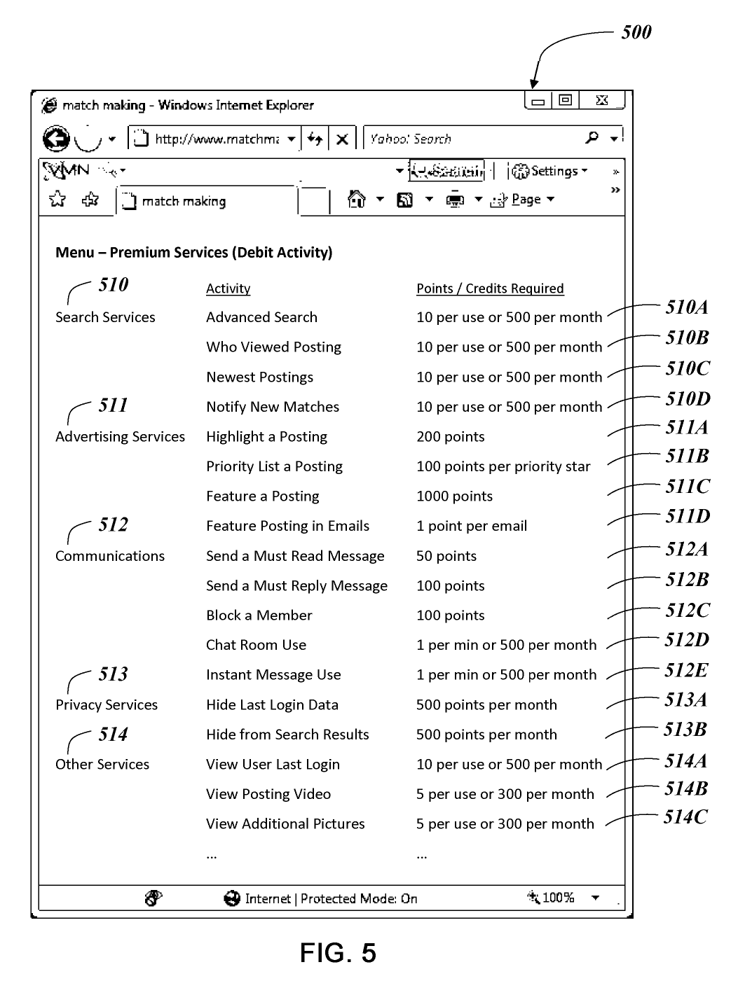

FIG. 2 is a flow chart illustrating an exemplary process for awarding and redeeming loyalty points in a loyalty system, in accordance with an embodiment of the present invention. In step 210 of the present embodiment, a user of a matchmaking website logs in to establish a session with the website server. In order to login, the user must first register for an account on the website, or must already be registered. The registration process to create an account on any website that supports user account and memberships is well known to those skilled in the art and will not be described herein. In addition, methods for logging onto any membership based websites are well known to those skilled in the art and will not be described herein. After logging in as shown in step 210, the user may use the matchmaking website by either performing step 211, where the user may browse the website, perform basic services or any reward tasks, or step 221, where the user uses a premium service or functionality. Basic services are functionalities that any registered user may perform for free, whereas premium services are functionalities that a registered user may use in exchange for incentive points he accumulates via the loyalty system of the present embodiment. Examples of what premium services may include are further provided by way of example in FIG. 5. A reward task is any task that results in the earning of incentive points via the loyalty system of the present embodiment. Examples of what reward tasks may include are provided by way of example in FIG. 4. Reward tasks are determined by the operator of the website, and generally are tasks that benefit the website operator. As such, when a user performs a reward task, the user is taking action on the website that generates some benefit to the website including, but not limited to, generating page views, which in turn allows the website to serve up more advertisements, performing an administrative task, which in turn allows the website to reduce manpower needed to operate the website, posting content and adding value to the website, or helping with viral marketing and attracting more users to the website. When the user performs reward tasks, the user is provided with the means to perform steps that generally assist the matchmaking service website in increasing revenue. Even using basic services, a registered user is generating page views, and therefore the use of basic services may be a reward task.

In the present embodiment, a user who is logged in and chooses to use a basic functionality or perform a reward task in step 211 can earn loyalty points. Upon using a basic functionality or performing a reward task in step 211, the system in step 212 determines the number of points that should be credited to the user's account. The number of points with which to credit a user's account depends on the type of task or activity performed, and the number of points awarded for each specific task may be set or customized by the operator of the website. Once the number of points to be awarded for the task or activity performed in step 211 is determined in step 212, the system credits said points to the user's account in step 213. The system provides the means by which the user can take the steps to acquire loyalty points, thus encouraging consistent and productive use of the service.

A user who is logged in may also choose to perform step 221. In step 221, the user selects to use a premium service provided by the matchmaking website. Once a premium service has been selected, the system determines the number of points required to perform the service in step 222. The number of points to be debited depends on the type of premium service or functionality, and the number of points needed for each service may be set or customized by the operator of the website. Once the number of points required is determined for the premium service selected in step 221, the system checks to make sure the user has a sufficient number of loyalty points in his account in step 223. If the system determines in step 223 that the number of points is insufficient, the premium task is not performed and the user may be informed and then allowed to continue using the website by performing step 211 to earn enough points before trying again. However, if the system determines in step 223 that the user has sufficient points to use the premium service, the appropriate number of loyalty points are debited from the user's account and the user may complete the selected premium service in step 224. By the user taking the steps of choosing the premium service, the user enhances the use of the matchmaking service website.

After completing either step 213 or step 224, the user may repeat the process of performing step 211 to earn more points, step 221 to use additional premium services, or step 230 to log out thereby terminating the session with the website. In summary, FIG. 2 describes one embodiment of the incentive system of the present invention, showing how a matchmaking website can provide an incentive credit and debit system for its registered users by performing tasks to earn credits, and debits for the use of premium services as determined by a set of loyalty system rules.

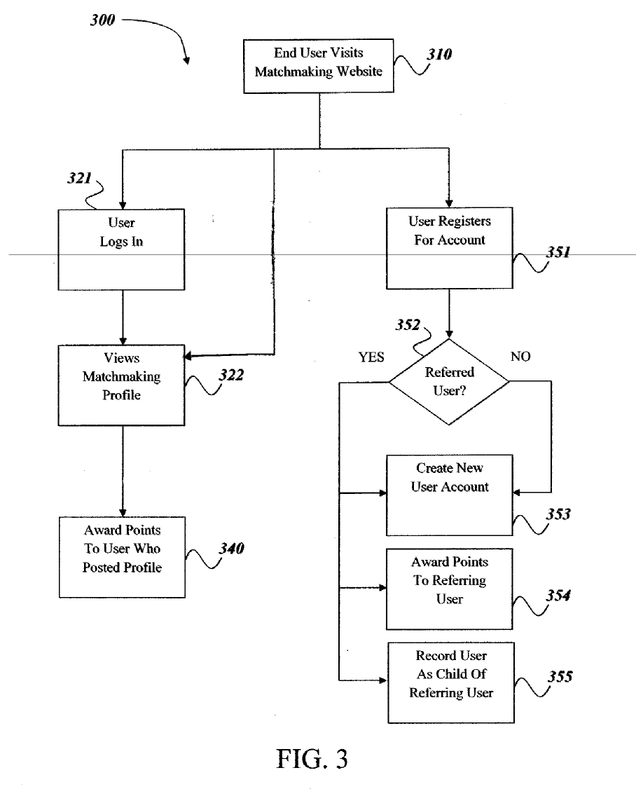

FIG. 3 is a flow chart illustrating an exemplary process for awarding loyalty points to a user based on the actions of other users, in accordance with an embodiment of the present invention. In step 310, a user visits a matchmaking website. The user may be directed to the website in many different ways, for example, without limitation, by way of directly typing the domain URL into the browser, via a saved browser bookmark or indirectly via a link on another web page. The user may also access the website using a client application that is designed specifically to display data received from matchmaking servers 111, and sending user input back to servers 111, for example, an iPhone application, software running on an internet enabled Kiosk, a Facebook.com plugin, etc. In the present embodiment, the matchmaking website may require the visiting user to perform a login step 321 before being allowed to search or view other member's postings in step 322, or the matchmaking website may enable the visiting user to search and view postings in step 322 without being required to login. In either case, when a user views a posting or profile in step 322, a page view is generated for the website, and on that same page, the website operator may place one or more advertisements, such as, but not limited to, the type served up by advertisement server 112, shown by way of example in FIG. 1. In another embodiment, the advertisement may be displayed as an interstitial prior to displaying content from the website, or in a separate pop-up window before, during or after displaying content from the website. In another embodiment, content of the website may be delivered to a mobile device and an opt-in text message may be displayed to the user before or after the website content is delivered. In yet another embodiment, content from the website is delivered using voice over the telephone and a pre-recorded advertisement message may be played to the user prior to the delivery of the content.

This enables the website to generate revenues by selling such advertising inventory. In the present embodiment, the viewing of a posting or profile by a user in step 322 results in the system awarding incentive credits or loyalty points in step 340 to the user who created the viewed posting or profile. Preferred embodiments of the present invention also make similar provisions for rewarding registered users who make contributions to the matchmaking website other than posing a profile or posting that help to generate page views for the website. Such contributions may include, without limitation, posting a photo, comment, video, participating in user forums, participating in chats, referring users, etc.

In some embodiments a higher number of loyalty points or incentive credits may be awarded in step 340 to the user who posted the viewed posting if the user is responsible for bringing a new visitor to the website. By awarding more points in step 340, the user who posted the profile or posting may be motivated to advertise the URL link for the posting on other websites, and as such help to draw new users to the matchmaking website through a click-through via the advertised URL link. Methods for tracking new or existing users to a website such as, but not limited to, the use of cookies or unique IP addresses are well known to those skilled in the art and will not be discussed herein. In embodiments that track new visitors, a new visitor may be discovered by checking to see if a website cookie exists on the client device of the visitor from a prior visit. If no cookie from the website exists, this implies that the visitor is new, and, if a registered user generated the visitor lead through a URL link for his posting, this registered user is awarded extra loyalty points.

In the present embodiment upon visiting the website, a new visitor may initiate step 351 to register for an account with the matchmaking website. The new visitor may have been referred to the website by a registered user. For example, without limitation, to encourage viral marketing, registered users of the website may be asked to provide email addresses of their friends. The website may then send out an email inviting the user's friends to visit the website. A URL link may be placed within the body of the email message containing code that identifies the referring registered user. In yet another viral marketing method in use with the present embodiment, a URL link that comprises code identifying the referring registered user may be advertised on other websites. This allows users to attract referrals. In step 352 the system determines if the registering user was referred by another registered user of the website. The identity of a referring user may be determined using various means including, but not limited to, determining if the referred user visits the website through a URL link containing code that identifies the referring user, determining if there is a match between the email supplied by a referring user and the email used by the referred user to register for an account, through the use of cookies placed on the referred user client device by the matchmaking server on a prior visit whereby information about who the referring user may be contained within the cookie, asking the referred user to provide the email address, username, or unique identification code of the registered user who referred them to the website during the registration process, etc.

If no referring user is found in step 352, the website creates a new user account for the new user in step 353. However, if a referring user is found in step 352, the website performs step 353 to create an account for the new user, step 354 to award loyalty points to the referring user's account, and step 355 to record the new user as a child of the referring user and the referring user as a parent to the new user. The three steps 353, 354 and 355, may occur concurrently, in parallel or in sequence, and in any order. In an alternate embodiment that does not use a multi-level reward system creating parent and child users, step 355 may not be performed.

FIG. 4 illustrates an exemplary website page view 400, listing an exemplary list of reward tasks, in accordance with an embodiment of the present invention. A reward activity may be any task that results in the earning of incentive points via a loyalty system according to preferred embodiments of the present invention for example, without limitation, using the website, contributing to viral marketing, posting content to the website, performing administrative tasks, flagging other users for potential fraud, submitting a constructive comment or feedback, referring new users, responding to a message from another user, providing a testimonial, etc. Website page view 400 is intended to show an example embodiment of the present invention, and it should be noted that the operator of the matchmaking service may add any other reward tasks to the list of reward tasks or may omit reward tasks from the list. It is also important to note that the reward tasks may vary depending on the type of matchmaking service provided by the website, for example, without limitation, dating, employment, search, ecommerce, auction, question-answer, etc. For example, reward tasks on a dating matchmaking website may involve users improving the experience of other users through the act of responding to messages they receive, or increasing the value of the website by uploading more photos to their profile. On the other hand, reward tasks for an employment matchmaking website may involve employers providing job seekers with a progress report on their application submission so as to improve job seeker experience, or employers providing job seekers with feedback on their resume.

The matchmaking service operator may choose to classify the list of reward tasks into categories, as shown by way of example in website page view 400. In the present embodiment, website page view 400 comprises the following classifications: a website usage category 410, a viral marketing category 411, a contribution category 412, an administrative category 413, and a miscellaneous category 414. Alternate embodiments may not classify the list of reward tasks into categories or various different categories may be used for example, without limitation, “fraud prevention category” to classify all activities that reduces online fraud, “user demographic category” to classify all activities that lead to collecting better demographic information, or “experience improvement category” to classify all activities that lead to better user experience for other users.

In the present embodiment, website usage category 410 illustrates a number of example tasks that are intended to increase user loyalty and page views. A login activity 410A awards points to a user for logging onto the website the first time each day. In some embodiments a larger number of points may be awarded to the user for logging into the website regularly, for example, without limitation, awarding double points for logging in two days consecutively, triple points for logging in three days consecutively, etc. In the present embodiment, a view website pages activity 410B awards points for viewing new pages on the website. Points are awarded only after a predetermined time period after the last page view to avoid fraud. In the present embodiment, points are awarded after a one-minute interval; however, the website operator may configure this time period to be shorter or longer in alternate embodiments, and in other alternate embodiments, points may be awarded without waiting a predetermined time period. In the present embodiment, a write message activity 410C awards points to a user for writing a message to another user. A read message activity 410D awards points to a user for reading a message received from another user, and a respond to a message activity 410E awards points to a user for responding to a message received from another user. In some embodiments these points may only be awarded if both users have never logged onto the website via the same IP address within a specified time period to avoid fraud. More website usage activities may be added to this list at the discretion of the operator of the website or service such as, but not limited to, clicking or viewing advertisements or banner links, PLEASE LIST EXAMPLES OF OTHER USAGE ACTIVITIES THAT MAY BE INCLUDED IN THIS LIST HERE], keeping in mind that an intention of website usage category 410 is to award loyalty points to encourage consistent and productive use of the service.

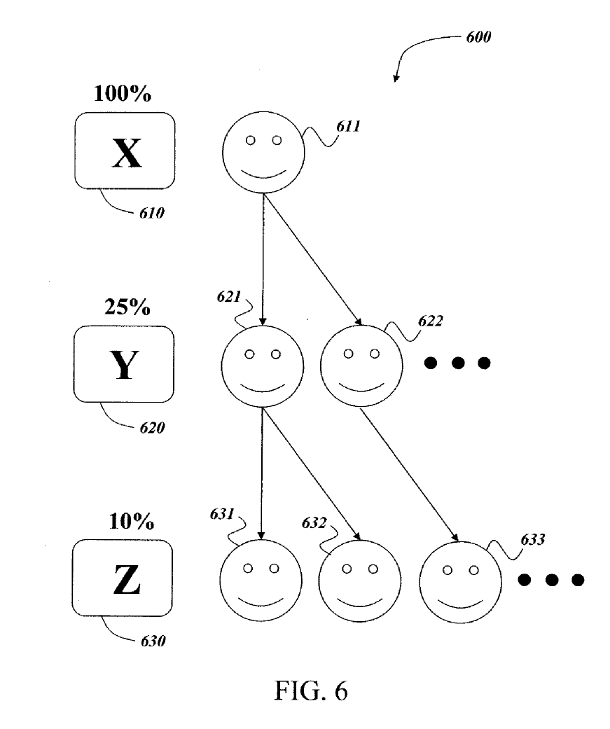

Viral marketing category 411 illustrates a number of example tasks that are intended to encourage viral marketing. A provide a valid referral email activity 411A awards points to a user for providing a valid referral email belonging to a friend who may be interested in using the matchmaking service, allowing the operator of the service to reach out to the referral by sending an email inviting him or her to use the website. A refer new user registration activity 411B awards points to a user for referring a new user who registers to use the website, a process described, by way of example, by steps 351 and 352 in FIG. 3. An active child member activity 411C awards a certain percentage of points earned by any child user to the parent user, while an active grandchild activity 411D awards a certain percentage of points earned by any grandchild user to the grandparent user. The multi-level nature of the incentive system as described in activities 411C and 411D is illustrated in detail by way of example in FIG. 6. In the present embodiment, the user earns 25% of points earned by a child user and 10% of points earned by a grandchild user; however, users may earn different percentages of points for child and grandchild users in alternate embodiments. In the present embodiment, generate a lead to website activity 411E awards points to a user for bringing a first time visitor to the website through a URL link. More viral marketing activities may be added to this list at the discretion of the operator of the website or service for example, without limitation, adding a traceable link back to the website via a social network or handing out marketing materials with a unique registration code traceable back to the user, keeping in mind that an intention of viral marketing category 411 is to award loyalty points to encourage users to help advertise the website to their friends, family and others.

Contribution category 412 illustrates a number of example tasks that are intended to encourage users to contribute content or add value to the website. An upload a photo/video activity 412A awards points to a user for uploading a photo or video to the website. In an alternate embodiment of the present invention, points may be subtracted if a user removes a photo or video that was posted before if the user does not replace the removed photo or video with an acceptable replacement. In the present embodiment, a post a posting/profile activity 412B awards points to a user for posting a new posting or profile to the website. More content contribution activities, such as, but not limited to, publishing an article, providing feedback, posting to a discussion group, posting an announcement, posting a classifieds listing, posting a resume, posting a blog, etc. may be added to this list at the discretion of the operator of the website or service, keeping in mind that an intent of viral marketing category 412 is to award loyalty points to encourage users to add content that may be valuable to other users.

Administrative tasks category 413 illustrates a number of example tasks that are intended to encourage users to help perform administrative tasks, thereby reducing the operating cost for the operator of the matchmaking service. A flagging a spammer activity 413A awards points to a user for notifying the operator of the website that another user is suspected of spamming. To encourage users to provide accurate notification, the operator of the website may reverse any points awarded through activity 413A if the notification is found to be not true. A flagging an inappropriate post activity 413B awards points to a user for notifying the operator of the website that a posting is inaccurate, contains inappropriate information, or violates the terms of use of the service. More administrative tasks, such as, but not limited to, approving entries, moderating discussion groups, moderating chat rooms, providing assistance to other users, adding content to self help or frequently asked questions, reporting inaccurate content on the website, reporting functionality or services that fail to work properly, etc. may be added to this list at the discretion of the operator of the website or service, keeping in mind that an intent of administrative task category 413 is to award loyalty points to encourage loyal users to help in maintaining or moderating the content or other users of the website, hence reducing the operating cost associated with administering the matchmaking services.

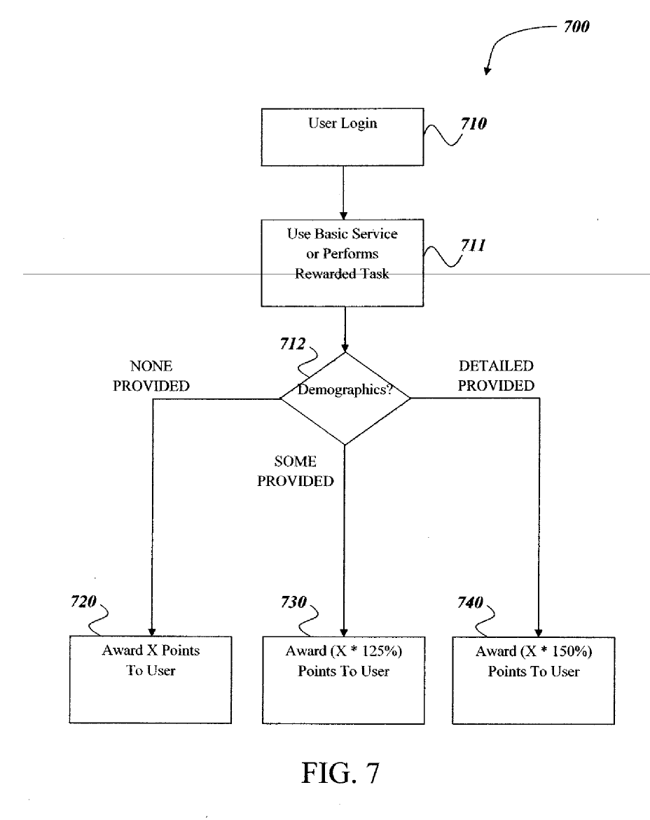

Miscellaneous tasks category 414 illustrates any other tasks that the operator of the website or service may want to encourage users to perform. For example, without limitation, a fill out demographic data activity 414A awards an increased percentage of points earned to a user who provides detailed demographic information to the website, who may in turn monetize such data by being able to serve higher priced targeted advertisements to the user. By providing the demographic information, the user is taking a steps for increasing a rate of receiving incentive points. An exemplary process for awarding additional points to a user for performing activity 414A is illustrated in detail by way of example in FIG. 7. Another activity that enables the operator of the website to further monetize the value of a user is through opt-in email notifications, whereby an email-based advertisement may be sent to a user who opts-in to receive such messages. A receive opt-in email activity 414B awards points to users each time an opt-in email is successfully sent to his mailbox. A read an opt-in email activity 414C awards points to users each time they read an email they receive from the website.

The operator of the matchmaking service or website may configure the system to enable users earn loyalty points in many different ways. For example, without limitation, in one embodiment of the present invention, the operator of the website may configure the incentive system to award an increasing percentage of points to users who have been an active member for a longer period of time. For instance, without limitation, a user who has been actively using the system for over a year may be awarded 20% more points than a new user for the same activity. In yet other embodiments, registered user may be able to purchase loyalty points or incentive credit. In another embodiment, the operator of the website may configure the incentive system to award an increasing percentage of points to users who are more popular, or for posting profiles or entries that are in higher demand by other users. Other ways for users to earn loyalty points may include, without limitations, filling out an online survey, responding to an advertiser's offer, responding to an email offer from the website operator, or accepting a loyalty point gift from another member.

FIG. 5 illustrates an exemplary website page view 500, listing an exemplary list of premium services, in accordance with an embodiment of the present invention. These premium services offered by the matchmaking service are intended to provide a user with a higher level of service or a better end-user experience. In the present embodiment, premium services represent functionality or services that are available to any registered users in exchange for loyalty points awarded via a loyalty system. Website page view 500 is intended to show an example embodiment of the present invention, and it should be noted that the operator of the matchmaking service may add any other premium services to the premium services list or omit services from this list. It is also important to note that premium services may vary depending on the type of matchmaking service provided, for example, without limitation, dating, employment, search, ecommerce, auction, question-answer, etc. The matchmaking service operator may choose to classify the list of premium services into categories, as shown by way of example in website page view 500. In the present embodiment, website page view 500 comprises the following classifications: a search services category 510, an advertising category 511, a communication services category 512, a privacy services category 513, and an other services category 514. Alternate embodiments may not classify the list of premium services into categories, and in other alternate embodiments various different categories may be used for example, without limitation, notification services category, detailed information category, news services category, discussion services category, user forum category, etc.

Search services category 510 illustrates a number of example premium search functionalities that a user may redeem with points, allowing the more loyal users to experience a higher level of search capabilities. In the present embodiment, premium services may be offered to users in various ways for example, without limitation, a premium service may be redeemed for a fixed number of points per use, or a premium service may be used an unlimited number of times within a time interval in exchange for a fixed number of points. An advanced search service 510A provides more detailed search engine features than a basic search. For example, without limitation, while a basic search may only allow users to search postings by state, an advanced search may enable users to search postings by city or zip code. The operator of the matchmaking service may determine what additional targeted search criteria may be provided as premium services for users. A who viewed posting service MOB enables a user to see a list of other users who have viewed his postings or profile, allowing the user to proactively reach out to a potential match. A newest postings service 510C enables a user to view the newest postings or profiles, while all other users may only be able to view postings or profiles that were posted over a week ago. A notify new matches service MOD automatically notifies a user, via a telephone call, an SMS text message, an email, etc. each time a posting or profile matching the user's search criteria is found. The operator of the matchmaking service may configure the system to provide other premium search functionalities to be added to premium search services category 510 such as, but not limited to, the ability to search by age range, the ability to search by physical attributes, the ability to search for members who have viewed a poster's posting, or the ability to search by members who is currently online.

Advertising services category 511 illustrates a number of example premium services a user may redeem with points, allowing more loyal users to advertise their postings more prominently to other users who may be potential matches. In the present embodiment, users exchange a fixed number of points for each use of a premium service in advertising category 511. However, in alternate embodiments, users may access premium services in advertising category 511 in various different ways such as, but not limited to, exchanging a set number of points for unlimited use of the service within a set time interval. A Highlight a posting service 511A enables a user to highlight his posting, thereby bringing more attention to his posting in exchange for a number of loyalty points per post. The posting may be highlighted using various means; for example, without limitation, highlighting a post may involve displaying the posting headline in bold, in a different font, in a different color, underlined, etc. A priority list a posting service 511B enables a user to list a posting at a higher priority level as compared to other similar posts. For example, without limitation, postings with a higher number of priority stars may be displayed or listed first in any comparable search results, whereby each priority star may be redeemable with a fixed number of points. In this example it is therefore up to the user to bid up the priority of his posting by obtaining the appropriate number of priority stars for his posting. The present embodiment also provides a feature a posting service 511C, which enables users to advertise their posts by featuring the posting in a banner advertisement to other users. A feature a posting in emails service 511D enables a user to advertise a posting by featuring a link to the posting in emails sent to other members, such as, but not limited to, email newsletters or email notifications. The operator of the matchmaking service may configure the system to provide other premium advertising functionalities to be added to premium advertising services category 511, such as, but not limited to, featuring a posting on the homepage, featuring a posting when a specific keyword is searched, featuring a posting to members visiting from a matching geo-location, or featuring a posting on other websites, etc.

Communication services category 512 illustrates a number of example premium communication functionalities, allowing loyal users the ability to more effectively communicate with other users. In the present embodiment, premium services in communication services category 512 may be redeemed for a fixed number of points per use or may be used an unlimited number of times within a time interval in exchange for a fixed number of points. However, in alternate embodiments, users may access premium services in communication services category 512 in various different ways such as, but not limited to, exchanging a number of points for each minute of use, exchanging a number of points depending on the number of characters or word count of the message, or exchanging a number of points for sending a message where the number of points depends on how popular or in-demand a posting may be, etc. A send a must read message service 512A enables a user to send another user a must read message for a fixed number of points per message, whereby the recipient of the must read message is required to open the message before being allowed to continue using the website. A send a must reply message service 512B enables a user to send another user a must reply message for a fixed number of points per message, whereby the recipient of the must reply message is required to provide a response to the recipient before being allowed to continue using the website. A block a member service 512C enables a user to block an unwanted user from being able to contact him. A chat room service 512D permits the user to use chat room services. An instant message use service 512E enables the user to use instant messenger services in exchange for loyalty points. In the present embodiment the operator of the matchmaking service may require users to redeem a fixed number of points for each minute of chat room or instant message usage, or the user may be allowed unlimited use of the chat room or instant messenger within a time interval in exchange for a fixed number of points. The operator of the matchmaking service may determine if other communication functionalities may be added to the premium communication services category 512, such as, but not limited to, delivering a message to the recipient's mobile phone, be informed or paged when another user logs on, record and deliver a voicemail message to another user, placing a call to another user's telephone via the website, receiving a call from another user without disclosing a phone number, etc.

Privacy services category 513 illustrates a number of example privacy options allowing loyal users the ability to maintain their privacy or remain anonymous while using the matchmaking services. In the present embodiment, such privacy services are redeemable for a fixed number of points per month. However in alternate embodiments, users may access premium services in privacy services category 513 in various different ways such as, but not limited to, redeeming a fixed number of points per use of the privacy services. A hide last login data service 513A enables a user to hide his last login information from other users. A hide from search results service 513B enables a user to hide his postings or profiles from search results. In alternate embodiments the hide from search results service may enable a user to hide his postings or profile from the search results of a selected group of users, determined by various criteria, for example, without limitation, by location, by sex, by age, etc. The operator of the matchmaking service may configure the system to provide other premium privacy options to be added to the premium privacy services category 513, such as, but not limited to, hiding or displaying a user's online status, displaying a user's postings only to trusted members or members who have positive reviews, etc.

Other services category 514 illustrates any other premium services the operator of the website or service may want to provide to loyal users through the redemption of loyalty points. For example, without limitation, a view user last login service 514A enables a user to view another user's last login information, provided such information has not been hidden by the other user via hide last login data service 513A. In the present embodiment, the operator of the website can classify content on the website into basic content, available for viewing by everyone, and premium content, which may be viewed in exchange for loyalty points. A view posting video service 514B enables a user to view a video uploaded by another user for a specific posting or profile that is considered premium content. A view additional pictures service 514C enables a user to view additional pictures or photos uploaded by another user for a specific posting or profile that is considered premium content.

Referring to FIG. 5 website page view 500 is intended to show examples of premium services that are possible, and it is up to the operator of the matchmaking service to configure the matchmaking system accordingly to provide a discriminating level of service, thereby providing better services for the more loyal users who have accumulated loyalty points through the loyalty system. The operator of the matchmaking service or website may configure the system to enable users to use earned loyalty points in many different ways. In an alternate embodiment of the present invention, loyalty points earned by a user may be transferred or gifted to another user. In another alternate embodiment, such loyalty points may be redeemed for cash, physical goods, or other online or offline services. In yet another alternate embodiment of the present invention, the operator may configure the loyalty system to work across multiple matchmaking services, allowing each user the ability to earn and spend their loyalty points interchangeably and seamlessly across any of those websites.

FIG. 6 is a diagram 600 illustrating an exemplary method of how points may be awarded in a multi-level incentive system, in accordance with an embodiment of the present invention. A multi-level incentive system is described by way of example in reference to active child member activity 411C and active grandchild member activity 411D in FIG. 4. In the present embodiment when a user 621 or 622 registers for an account on the website via a referral from a user 611, a child to parent relationship is recorded, as described by way of example in step 355 of FIG. 3, whereby the parent is user 611 and the child is user 621 or 622. The parent to child relationship between user 611 and user 621 or 622 is represented by an arrow from user 611 to user 621 and from user 611 to user 622 in FIG. 6. Similarly, the parent to child relationship exists between user 621 and users 631, 621 and 632, as well as user 622 and a user 633. Since user 611 is the parent of user 621, and user 621 is the parent of user 631, it therefore implied that user 611 and user 631 have a grandparent to grandchild relationship, whereby user 611 is the grandparent and user 631 is the grandchild. Similar grandparent and grandchild relationships exist between user 611 and user 632, and user 611 and user 633 in FIG. 6.

In the present embodiment, user 611 is awarded X number of loyalty points, as shown in a box 610, based on the user's own activity on the website. A box 620 shows the total number of loyalty points, Y, earned by all users whose parent user is user 611. In this example, Y represents the total of all the loyalty points awarded to users 621 and 622. A box 630 shows the total number of loyalty points, Z, earned by all users whose grandparent user is user 611. In this example, Z represents the total of all the loyalty points awarded to users 631, 632 and 633.

Based on rules described by way of example in reference to active child member activity 411C, shown by way of example in FIG. 4, a user is awarded 25% of loyalty points awarded to all child members. As such, in the present example, user 611 is awarded 25% of box 620, or 25% of Y. Furthermore, based on rules described by way of example in reference to active grandchild member activity 411D, shown by way of example in FIG. 4, a user is awarded 10% of loyalty points awarded to all grandchild members. As such, in the present example, user 611 is awarded 10% of box 630, or 10% of Z. Accordingly, the total number of points awarded to user 611 as shown in diagram 600 of FIG. 6 is X+(0.25×Y)+(0.10×Z).

While diagram 600 of FIG. 6 describes how one embodiment of a multi-level award system may be implemented, the operator of the matchmaking service or website may choose to configure such a multi-level award system in many different ways. In an alternate embodiment, additional levels may be added to the incentive system, whereby each user may be awarded a percentage of all points awarded to great-grand-child members. In other alternate embodiments, the percentage of points awarded to a parent member based on child members at different levels may be changed. In yet other alternate embodiments, the operator may choose to not implement a multi-level award system, and may only award points to users who perform the reward activities.

FIG. 7 is a flow chart illustrating an exemplary process for awarding more loyalty points to users who have provided more demographic data about themselves, in accordance with an embodiment of the present invention. This demographic data may include, without limitation, information about themselves, their preferences or their environment. Armed with additional demographic information, the operator of the matchmaking service may target the delivery of online advertisement to end-users. Since advertisers are willing to pay a higher rate for targeted advertisements, this process is intended to enable the operator of the service or website to increase the value of each end-user.

In step 710, a registered user logs onto the matchmaking website. As the user uses the website or service in step 711 to perform an award activity such as, but not limited to, the reward activities shown by way of example in FIG. 4, step 712 is performed to check if the user has provided his demographic information. The operator of the website may create many levels of demographic details, which may include information such as, but not limited to, age, location, income, marital status, education, occupation, number of children, hobbies, political affiliation, religion, personal interests, consumer preferences, etc. Such demographic details may then be designed into questionnaires to be filled out by users who may want to receive more award points. In some embodiments of the present invention, the operator of the website or service may make it optional for the users to answer such demographic questions, and in other embodiments, answering these questions may be compulsory. The operator of the website or service may also design the system to ask many questions at once, for example, without limitation, during registration, or to spread out the questionnaire by asking users to answer one question each time they login. In yet other embodiments of the present invention, the operator of the website or service may periodically ask the user to answer the same question or may pose the same question in a different way in order to ensure the accuracy of the demographic information or preferences provided.

In the present embodiment, a user who has provided more demographic information receives a higher percentage of award points than a user who provides less demographic information. In step 712, the system checks to see if the user has provided any demographic information. If no demographic information is provided, the system performs step 720 by awarding X points to the user for the specific activity performed. However, if some demographic information has been provided as determined by the operator of the matchmaking service or website, step 730 is performed where 1.25 times X points is awarded for the same activity performed. If detailed demographic information has been provided, step 740 is performed, and the user is awarded 1.50 times X points for the same activity performed.

While FIG. 7 shows one exemplary embodiment of the present invention with three levels of demographic detail, none, some and detailed, and their corresponding award levels, 100%, 125% and 150%, it should be noted that there are many possible embodiments of the present system. For example, without limitation, the operator of the website may configure the system to provide more or fewer demographic levels and award levels or to award various different percentages of points for the demographic levels. In some embodiments the user may receive a one-time lump sum of points at the time he provides the demographic information rather than receiving more points for each reward activity performed.

FIG. 8 illustrates a typical computer system that, when appropriately configured or designed, can serve as a computer system in which the invention may be embodied. The computer system 800 includes any number of processors 802 (also referred to as central processing units, or CPUs) that are coupled to storage devices including primary storage 806 (typically a random access memory, or RAM), primary storage 804 (typically a read only memory, or ROM). CPU 802 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 804 acts to transfer data and instructions uni-directionally to the CPU and primary storage 806 is used typically to transfer data and instructions in a bi-directional manner. Both of these primary storage devices may include any suitable computer-readable media such as those described above. A mass storage device 808 may also be coupled bi-directionally to CPU 802 and provides additional data storage capacity and may include any of the computer-readable media described above. Mass storage device 808 may be used to store programs, data and the like and is typically a secondary storage medium such as a hard disk. It will be appreciated that the information retained within the mass storage device 808, may, in appropriate cases, be incorporated in standard fashion as part of primary storage 806 as virtual memory. A specific mass storage device such as a CD-ROM 814 may also pass data uni-directionally to the CPU.

CPU 802 may also be coupled to an interface 810 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 802 optionally may be coupled to an external device such as a database or a computer or telecommunications or internet network using an external connection as shown generally at 812, which may be implemented as a hardwired or wireless communications link using suitable conventional technologies. With such a connection, it is contemplated that the CPU might receive information from the network, or might output information to the network in the course of performing the method steps described in the teachings of the present invention.

Alternate embodiments of the present invention may be implemented that provide specifically defined service levels that unlock premium services to registered users. In these embodiments the user earns points by performing reward tasks as described by way of example in the foregoing. However, rather than exchanging these points for individual premium services, registered users collect points to reach higher service levels, and each service level provides more premium services to the user. For example, without limitation, in one system with service levels users with 0-250 points have basic level status where only the basic services are accessible, users with 250-500 points have bronze level status where some premium services are accessible, users with 500-1000 points have silver level status where more premium services are accessible, and users with more than 1000 points have gold level status where all of the premium services are available. The operator of the service or website can configure these embodiments to comprise more or fewer service levels and may set the points required to reach these levels to whatever he feels is appropriate.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, one or more application server(s), one or more database server(s), one or more steps associated with the process of redeeming or awarding loyalty points as shown in FIG. 2., FIG. 3., or FIG. 7. may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing loyalty systems for online services according to the present invention will be apparent to those skilled in the art. The invention has been described above by way of illustration, and the specific embodiments disclosed are not intended to limit the invention to the particular forms disclosed. For example, the particular implementation of the loyalty system may vary depending upon the particular type of website used. The websites described in the foregoing were directed to matchmaking websites; however, similar techniques are to implement loyalty systems on different types of websites such as, but not limited to, blogs, gaming websites, websites representing specific entities, etc. Non-matchmaking implementations of the present invention are contemplated as within the scope of the present invention. The invention is thus to cover all modifications, equivalents, and alternatives falling within the spirit and scope of the following claims.

What is claimed is:

1. A method of using a system for advertising supported matchmaking services, the method comprising:
steps for accessing a first basic set of matchmaking functionalities on a first matchmaking service website;
steps for generally assisting said first matchmaking service website in increasing revenue;
steps for encouraging generally consistent and generally productive use of said first matchmaking service website; and
steps for enhancing a use of said first matchmaking service website.

2. The method as recited in claim 1, further comprising steps for increasing a rate of receiving incentive points.

3. The method as recited in claim 1, further comprising steps for posting to attract referrals.

4. The method as recited in claim 1, further comprising steps for inviting a recipient to register at said first matchmaking service website.

5. The method as recited in claim 1, further comprising:
steps for referring a new user for registration; and
steps for receiving a first percentage of incentive points received by said new user.

6. The method as recited in claim 5, further comprising steps for receiving a second percentage of incentive points received by an additional new user referred by said new user.

7. The method as recited in claim 1, further comprising steps for accessing a second basic set of matchmaking functionalities on a second matchmaking service website.

8. The method as recited in claim 7, further comprising:
steps for generally assisting said second matchmaking service website in increasing revenue; and
steps for encouraging generally consistent and generally productive use of said second matchmaking service website, wherein incentive points received at said first matchmaking service website and said second matchmaking service website are combined.

9. A system for advertising supported matchmaking services, the system comprising:
means for accessing a first basic set of matchmaking functionalities on a first matchmaking service;
means for generally assisting said first matchmaking service website in increasing revenue;
means for encouraging generally consistent and generally productive use of said first matchmaking service website; and
means for enhancing a use of said first matchmaking service website.

10. The system as recited in claim 9, further comprising means for increasing a rate of receiving incentive points.

11. The system as recited in claim 9, further comprising means for posting to attract referrals.

12. The system as recited in claim 9, further comprising means for inviting a recipient to register at said first matchmaking service website.

13. The system as recited in claim 9, further comprising:
means for referring a new user for registration; and
means for receiving a first percentage of incentive points received by said new user.

14. The system as recited in claim 13, further comprising means for receiving a second percentage of incentive points received by an additional new user referred by said new user.

15. The system as recited in claim 9, further comprising means for accessing a second basic set of matchmaking functionalities on a second matchmaking service website.

16. The system as recited in claim 15, further comprising:
means for generally assisting said second matchmaking service website in increasing revenue; and
means for encouraging generally consistent and generally productive use of said second matchmaking service website, wherein incentive points received at said first matchmaking service website and said second matchmaking service website are combined.

17. A method of using a system for advertising supported matchmaking services, the method comprising steps of:
logging onto a first matchmaking service website for accessing a first basic set of matchmaking functionalities;
completing at least one specified action on said first matchmaking service website for generally assisting said first matchmaking service website in increasing revenue;
receiving incentive points associated with said completing of said at least one specified action for encouraging generally consistent and generally productive use of said first matchmaking service website; and
receiving a list of premium matchmaking functionalities for enhancing a use of said first matchmaking service website, wherein use of each of said premium matchmaking functionalities requires a predetermined number of said incentive points.

18. The method as recited in claim 17, further comprising the step of selecting a one of said premium matchmaking functionalities dependent on a number of received incentive points.

19. The method as recited in claim 18, wherein said number of received incentive points is decreased by said predetermined number of said incentive points for said one of said premium matchmaking functionalities.

20. The method as recited in claim 17, wherein said first basic set of matchmaking functionalities and said list of premium matchmaking functionalities are divided into a plurality of service levels where each of said service levels requires a differing number of incentive points for using functionalities contained within each of said service levels.

21. The method as recited in claim 17, further comprising steps of:
providing demographic information for increasing a rate of receiving incentive points; and
receiving incentive points for providing said demographic information.

22. The method as recited in claim 17, further comprising the step of receiving a link to said first matchmaking service website for posting to attract referrals, wherein said link identifies a referrer.

23. The method as recited in claim 17, further comprising the step of sending at least one email for inviting a recipient to register at said first matchmaking service website, where said email contains said link.

24. The method as recited in claim 23, further comprising the step of receiving incentive points for sending said email.

25. The method as recited in claim 17, further comprising the steps of:
referring a new user for registration; and
receiving additional incentive points amounting to a first percentage of incentive points received by said new user.

26. The method as recited in claim 25, further comprising the step of receiving further incentive points amounting to a second percentage of incentive points received by an additional new user referred by said new user.

27. The method as recited in claim 17, further comprising the step of logging onto a second matchmaking service website for accessing a second basic set of matchmaking functionalities.

28. The method as recited in claim 27, further comprising steps of:
completing at least one specified action on said second matchmaking service website for generally assisting said second matchmaking service website in increasing revenue; and
receiving incentive points associated with said completing of said at least one specified action for encouraging generally consistent and generally productive use of said second matchmaking service website, wherein incentive points received at said first matchmaking service website and said second matchmaking service website are combined.

29. The method as recited in claim 17, further comprising the step of redeeming incentive points for goods or services.

30. The method as recited in claim 17, further comprising the step of purchasing incentive points.

31. The method as recited in claim 17, wherein the first matchmaking service website is a dating website, employment website, auction website, commerce website, search website, classified service website or a social networking website.

32. A computer program product for a system for advertising supported matchmaking services, the computer program product comprising:
computer program code for logging onto a first matchmaking service website for accessing a first basic set of matchmaking functionalities;
computer program code for completing at least one specified action on said first matchmaking service website for generally assisting said first matchmaking service website in increasing revenue;
computer program code for receiving incentive points associated with said completing of said at least one specified action for encouraging generally consistent and generally productive use of said first matchmaking service website;
computer program code for receiving a list of premium matchmaking functionalities for enhancing a use of said first matchmaking service website, wherein use of each of said premium matchmaking functionalities requires a predetermined number of said incentive points; and
a computer-readable media for storing the computer program code.

33. The computer program product as recited in claim 32, further comprising computer program code for selecting a one of said premium matchmaking functionalities dependent on a number of received incentive points.

34. The computer program product as recited in claim 32, wherein said number of received incentive points is decreased by said predetermined number of said incentive points for said one of said premium matchmaking functionalities.

35. The computer program product as recited in claim 32, wherein said first basic set of matchmaking functionalities and said list of premium matchmaking functionalities are divided into a plurality of service levels where each of said service levels requires a differing number of incentive points for using functionalities contained within each of said service levels.

36. The computer program product as recited in claim 32, further comprising:
computer program code for providing demographic information for increasing a rate of receiving incentive points; and
computer program code for receiving incentive points for providing said demographic information.

37. The computer program product as recited in claim 32, further comprising computer program code for receiving a link to said first matchmaking service website for posting to attract referrals, wherein said link identifies a referrer.

38. The computer program product as recited in claim 32, further comprising computer program code for sending at least one email for inviting a recipient to register at said first matchmaking service website, where said email contains said link.

39. The computer program product as recited in claim 38, further comprising computer program code for receiving incentive points for sending said email.

40. The computer program product as recited in claim 32, further comprising:
computer program code for referring a new user for registration; and
computer program code for receiving additional incentive points amounting to a first percentage of incentive points received by said new user.

41. The computer program product as recited in claim 40, further comprising computer program code for receiving further incentive points amounting to a second percentage of incentive points received by an additional new user referred by said new user.

42. The computer program product as recited in claim 32, further comprising computer program code for logging onto a second matchmaking service website for accessing a second basic set of matchmaking functionalities.

43. The computer program product as recited in claim 42, further comprising:
computer program code for completing at least one specified action on said second matchmaking service website for generally assisting said second matchmaking service website in increasing revenue; and
computer program code for receiving incentive points associated with said completing of said at least one specified action for encouraging generally consistent and generally productive use of said second matchmaking service website, wherein incentive points received at said first matchmaking service website and said second matchmaking service website are combined.

44. The computer program product as recited in claim 32, further comprising computer program code for redeeming incentive points for goods or services.

45. The computer program product as recited in claim 32, further comprising computer program code for purchasing incentive points.
